(19) United States
(12) Patent Application Publication
(10) Pub. No.: US 2007/0006221 A1
(43) Pub. Date: Jan. 4, 2007

(54) Software install environment constructing apparatus

(75) Inventor: Takahiro Nozaki, Kanagawa (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 11/441,228

(22) Filed: May 26, 2006

(30) Foreign Application Priority Data
May 27, 2005 (JP) 2005-155234

(51) Int. Cl. G06F 9/445

(52) U.S. Cl. 717/174

(57) ABSTRACT

A technology for constructing an environment for installing a software for using a device is disclosed. Device information on the device is acquired through a network. The software for using the device is obtained based on the device information acquired. A setting value for using the device is set, and the setting value is associated with the software obtained. An install image with which the software is installed is created based on the obtained software and the setting value associated with the software.

### BACKGROUND OF THE INVENTION

1. Field of the Invention

The present invention relates generally to software install environment constructing apparatuses, software install environment constructing methods, software install environment constructing program products, and recording media, and more particularly to a software install environment constructing apparatus, a software install environment constructing method, a software install environment constructing program product, and a recording medium for constructing an environment for installing a software required for using a device.

2. Description of the Related Art

In order to use a device connected to a computer, such as a printer, a facsimile machine, or a copier, a software (e.g. printer driver) needs to be installed in the computer. Such a software is distributed or provided in an install image (install package). An install image is typically created by a program. When the install image is being created, in order to identify the software to be included in the install image, a user is required to specify the place where the software is stored (path or URL) (see, for example, Japanese Laid-Open Patent Application No. 2004-86863).

However, because the user manually inputs the place of the software, the possibility of an error increases. For example, the user might erroneously specify a software that is irrelevant to the subject device for which the install image is being created. As a result, the install image would include the wrong software. If the wrong software is installed in the computer, the intended device cannot be used normally.

This problem also arises when creating an install image for a software that has been downloaded from a website. The user might erroneously select a software that does not match the subject device when downloading the software from the website.

### SUMMARY OF THE INVENTION

Accordingly, it is a general object of the present invention to provide a software install environment constructing apparatus, a software install environment constructing method, a software install environment constructing program product, and a recording medium in which the above-described disadvantage is eliminated.

A more specific object of the present invention is to provide a software install environment constructing apparatus, a software install environment constructing method, a software install environment constructing program product, and a recording medium that can create an install image that includes a software that matches a subject device.

The above objects of the present invention are achieved by an apparatus for constructing an environment for installing a software for using a device, including: an acquiring unit configured to acquire, through a network, device information on the device; an obtaining unit configured to obtain the software for using the device based on the device information acquired by the acquiring unit; a setting unit configured to set a setting value for using the device, and associate the setting value with the software obtained by the obtaining unit; and a creating unit configured to create an install image with which the software is installed, based on the obtained software and the setting value associated with the software.

The above objects of the present invention are also achieved by a method of constructing an environment for installing a software for using a device, including: acquiring, through a network, device information on the device; obtaining the software for using the device based on the device information acquired at the acquiring; setting a setting value for using the device, and associating the setting value with the software obtained at the obtaining; and creating an install image with which the software is installed, based on the obtained software and the setting value associated with the software.

The above objects of the present invention are also achieved by a program product that causes a computer to execute a procedure for constructing an environment for installing a software for using a device, the procedure including steps of: acquiring, through a network, device information on the device; obtaining the software for using the device based on the device information acquired at the acquiring; setting a setting value for using the device, and associating the setting value with the software obtained at the obtaining; and creating an install image with which the software is installed, based on the obtained software and the setting value associated with the software.

The above objects of the present invention are also achieved by a computer-readable recording medium storing therein the program product according to the present invention.

According to one embodiment of the present invention, a software install environment constructing apparatus, a software install environment constructing method, a software install environment constructing program product, and a recording medium capable of creating an install image that includes a software that matches a subject device, can be provided.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram of an install image creating system according to a first embodiment of the present invention;

FIG. 2 is a schematic diagram of a hardware configuration of an install image creating device according to an embodiment of the present invention;

FIG. 3 is a flowchart showing a processing procedure performed by an install image creating device according to the first embodiment of the present invention;

FIG. 4 is a flowchart showing a processing procedure performed by an install image creating device according to a second embodiment of the present invention;

FIG. 5 is a schematic diagram of an install image creating system according to a third embodiment of the present invention;

FIG. 6 is a flowchart showing a processing procedure performed by an install image creating device according to the third embodiment of the present invention;

FIG. 7 is a flowchart showing a processing procedure performed by an install image creating device according to a fourth embodiment of the present invention;

FIG. 8 is a flowchart showing a processing procedure performed by an install image creating device according to a fifth embodiment of the present invention; and

FIG. 9 is a flowchart showing a processing procedure performed by an install image creating device according to a sixth embodiment of the present invention.

### DETAILED DESCRIPTION OF THE PREFERRED EMBODIMENTS

A description is given, with reference to the accompanying drawings, of an embodiment of the present invention.

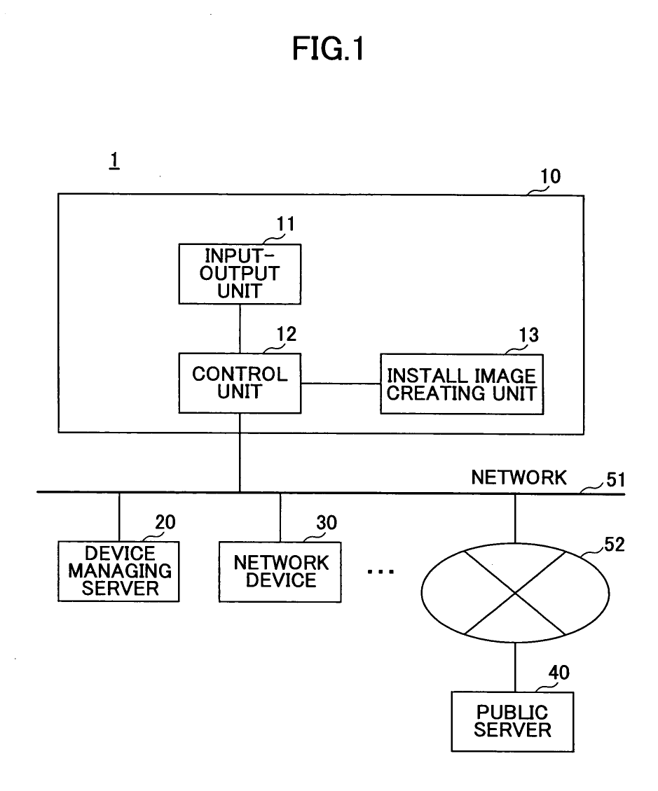

FIG. 1 is a schematic diagram of an install image creating system 1 according to a first embodiment of the present invention.

The install image creating system 1 includes an install image creating device 10, a device managing server 20, and at least one network device 30, which are interconnected by a network 51 such as a LAN (Local Area Network), and a public server 40 connected to the network 51 via a network 52 such as the Internet or an intranet. The network 51 and the network 52 can be wired or wireless.

The install image creating device 10 creates (constructs) an install package (hereinafter, “install image”), which is an environment for installing a software for using the network device 30. The install image creating device 10 is realized by a general-purpose computer such as a PC (Personal Computer). The install image creating device 10 includes an input-output unit 11, a control unit 12, and an install image creating unit 13.

The input-output unit 11 is used for communicating with a user with a GUI (Graphical User Interface). The control unit 12 controls the overall flow of a processing for creating an install image based on information input by the user via the input-output unit 11. The install image creating unit 13 creates an install image according to instructions from the control unit 12.

The device managing server 20 is a computer for managing the network device 30 connected to the network 51. The device managing server 20 automatically collects various attribute information regarding the network device 30 connected to the network 51, and unitarily manages the collected information.

The network device 30 is, for example, a printer, a copier, a facsimile machine, or a multifunction machine, which is used via the network 51.

The public server 40 is a computer that offers, e.g. on a website, a software module to be included in an install image.

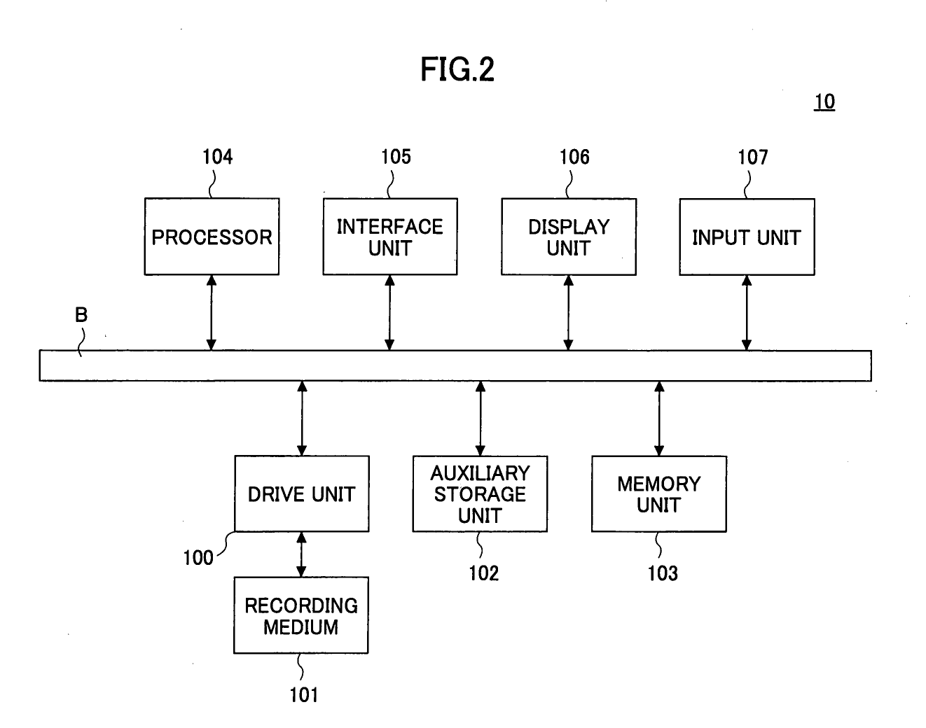

FIG. 2 is a schematic diagram of a hardware configuration of the install image creating device 10. The install image creating device 10 includes a drive unit 100, an auxiliary storage unit 102, a memory unit 103, a processor 104, an interface unit 105, a display unit 106, and an input unit 107, which are interconnected by a bus B.

A program for realizing the functions of the install image creating device 10 (the input-output unit 11, the control unit 12, the install image creating unit 13, etc.) is provided by a recording medium 101 such as a CD-ROM. When the recording medium 101 in which the program is recorded is set in the drive unit 100, the program is installed from the recording medium 101 into the auxiliary storage unit 102 through the drive unit 100.

The auxiliary storage unit 102 stores the installed program as well as necessary files and data. When an instruction to activate the program is received, the memory unit 103 reads the program from the auxiliary storage unit 102, and stores the program therein. The processor 104 executes functions of the install image creating device 10 according to the program stored in the memory unit 103. The interface unit 105 is used as an interface for connecting the install image creating device 10 to the network 51 shown in FIG. 1. The display device 106 displays a GUI according to the program. The input device 107 includes a keyboard and a mouse with which a user inputs various operation instructions.

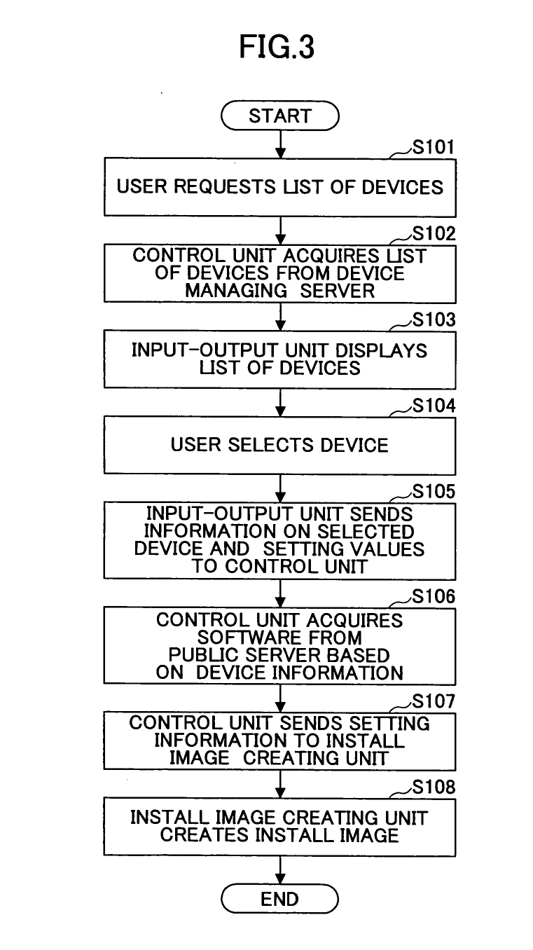

A processing procedure performed by the install image creating device 10 is described below. FIG. 3 is a flowchart showing the processing procedure performed by the install image creating device 10 according to the first embodiment.

The processing starts when a user (manager) inputs an instruction via the input-output unit 11 to display a list of devices (step S101). When a request for the list of devices is received from the input-output unit 11, the control unit 12 requests the device managing server 20 to provide the list of devices that are currently being managed by the device managing server 20. In response to the request from the control unit 12, the device managing server 20 sends the list of devices to the control unit 12 (step S102). The list of devices includes device information for each device (e.g., IP address, model name, model number, name and place of storage (folder name, URL, etc.) of a software module required for using the device, or any other information for identifying information that affects the install image). The control unit 12 outputs the list of devices received from the device managing server 20 to the input-output unit 11, and the input-output unit 11 causes the display unit 106 to display the list of devices (step S103).

The user selects, from the list of devices displayed, a device for which an install image is to be created, and inputs various setting values (hereinafter, “usage setting values”) required for using the selected device (step S104). When a device for which an install image is to be created is a printer, for example, a usage setting value is a default value of a printing parameter such as “print on both sides by default”. The device selected by the user is hereinafter referred to as “selected device”.

The input-output unit 11 outputs the values input by the user to the control unit 12 to request creation of an install image for the selected device (step S105). The control unit 12 acquires, from the public server 40, a software module required for using the selected device based on device information on the selected device, and associates the software module with the usage setting values (step S106). As the device information includes the name and place of storage of the software module required for using the selected device, the software module required for using the selected device is automatically determined based the device information.

The control unit 12 outputs the usage setting values and the acquired software module to the install image creating unit 13 (step S107). Based on the information received from the control unit 12, the install image creating unit 13 creates an install image with which the software module can be installed in accordance with the usage setting values, and stores the created install image in a predetermined area (folder) in the auxiliary storage unit 102 (step S108).

Accordingly, the install image creating device 10 according to the first embodiment automatically acquires a software module corresponding to a subject device based on device information, and creates an install image based on the acquired software module. Thus, the user does not need to manually input the place of storage of a software module when creating an install image. This configuration makes it possible to prevent creating an install image including a wrong software module due to an erroneous input by the user.

Next, a second embodiment is described. The structure of the install image creating system 1 according to the second embodiment is the same as that of the first embodiment (FIG. 1).

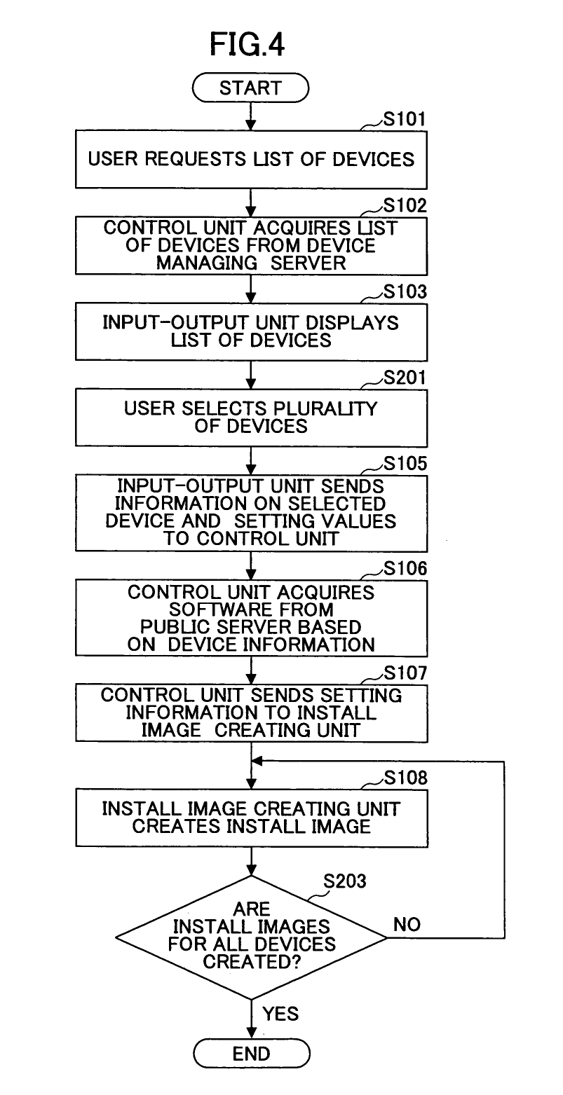

FIG. 4 is a flowchart showing the processing procedure performed by the install image creating device 10 according to the second embodiment. The steps common to those shown in FIG. 3 are denoted by common step numbers, and overlapping descriptions are omitted.

In step S201 of the second embodiment, the user selects a plurality of devices from the list of devices. The selected plurality of devices can be devices of the same model or devices of different models.

In steps S105 to S107, processing procedures for each of the selected devices are executed. For example, in step S106, software modules for each of the selected devices are acquired from respective public servers 40. However, if the selected devices are of the same model that require a common software, only one software module may need to be acquired.

In step S108, the install image creating unit 13 creates install images for each of the selected devices (step S203). If the selected devices are of the same model, the install images can be created at once, based on the same usage setting values and the same software module. However, information that is unique to each device, such as IP addresses, is individually set for each install image.

According to the install image creating device 10 of the second embodiment, even when install images are created for a plurality of devices, the same effects as the first embodiment can be achieved. Moreover, when the selected devices are of the same model, a common processing procedure is performed for all of the devices, thereby enhancing efficiency.

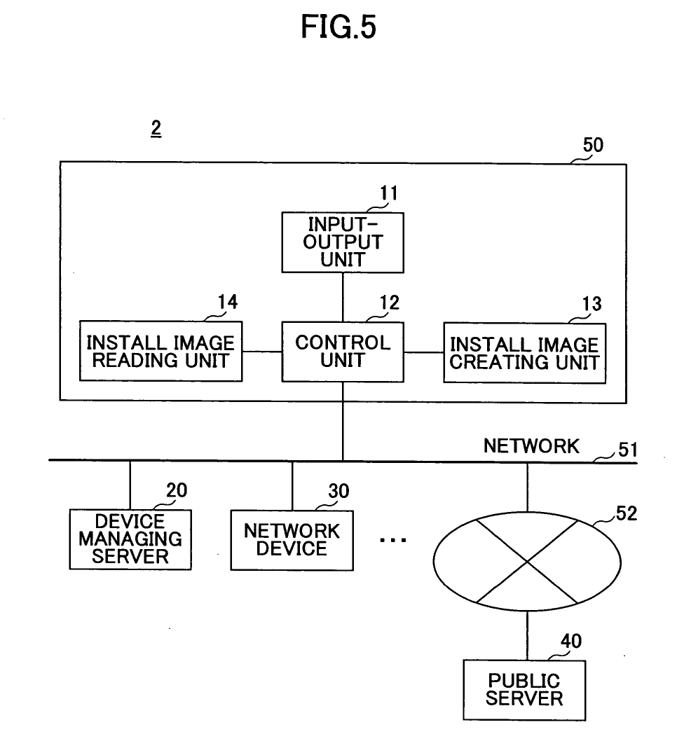

Next, a third embodiment is described. FIG. 5 is a schematic diagram of an install image creating system 2 according to the third embodiment of the present invention. The components common to those shown in FIG. 1 are denoted by common reference numerals, and overlapping descriptions are omitted.

An install image creating device 50 in the install image creating system 2 includes an install image reading unit 14, in addition to the components shown in FIG. 1.

The install image reading unit 14 manages an existing install image that has previously been created by the install image creating unit 13.

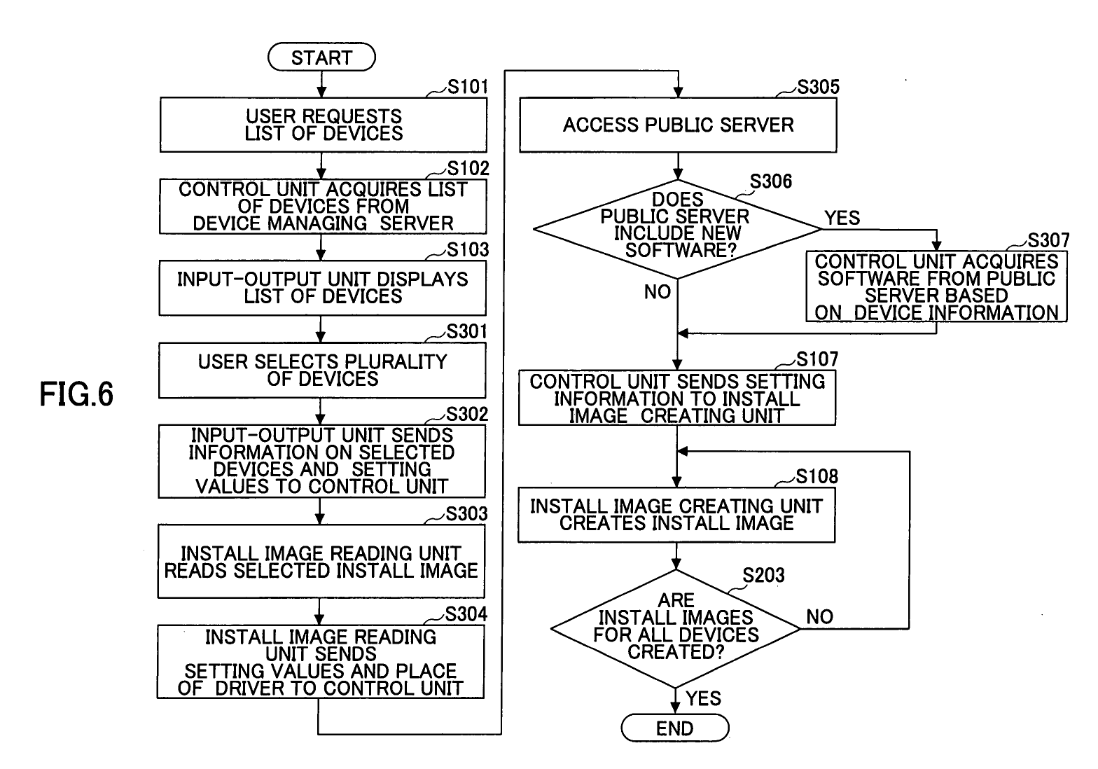

FIG. 6 is a flowchart showing the processing procedure performed by the install image creating device 50 according to the third embodiment. The steps common to those shown in FIG. 4 are denoted by common step numbers, and overlapping descriptions are omitted.

In step S301 of the third embodiment, the user selects a plurality of devices from the list of devices, inputs usage setting values, and also specifies a place, such as a folder, where an existing install image (hereinafter, “existing install image”) is stored (hereinafter, “existing install image storage place”), and inputs an instruction to read the existing install image and to create an install image by using the existing install image as a template. According to the user's instructions, the input-output unit 11 outputs values input by the user to the control unit 12 and requests creation of install images (step S302).

The control unit 12 notifies the install image reading unit 14 of the existing install image storage place, and the install image reading unit 14 reads the existing install image from the existing install image storage place (step S303). The install image reading unit 14 acquires, from the existing install image read, usage setting values and information on where a software module is stored (it is assumed here that a URL of the public server 40 is indicated), and outputs the acquired information to the control unit 12 (step S304).

The control unit 12 accesses the public server 40 based on the information on where the software module is stored (step S305), and if a new version of the software module is released (Yes at step S306), the control unit 12 acquires the new version (step S307).

The control unit 12 outputs the usage setting values, a list of selected devices, and the software modules to the install image creating unit 13 (step S107). When a new version of the software module is acquired, the new version is output to the install image creating unit 13. When a new version is not acquired, a software module included in the existing install image is acquired and output to the install image creating unit 13.

Subsequently, an install image is created and stored as described above.

According to the install image creating device 50 according to the third embodiment, an install image is created by using an existing install image as a template. The control unit 12 accesses the public server 40 to confirm whether there is a new version of a software module. This configuration makes it possible to create an install image including the latest software module without difficulty and without errors.

Next, a fourth embodiment is described. The structure of the install image creating system 1 according to the fourth embodiment is the same as that of the first embodiment (FIG. 1). In the fourth embodiment, the device managing server 20 periodically searches for a software module required for the network device 30 that is being managed. When a software module that is not stored in the device managing server 20, or a newer version than the software module stored in the device managing server 20 is found, the device managing server 20 acquires such a software module in advance.

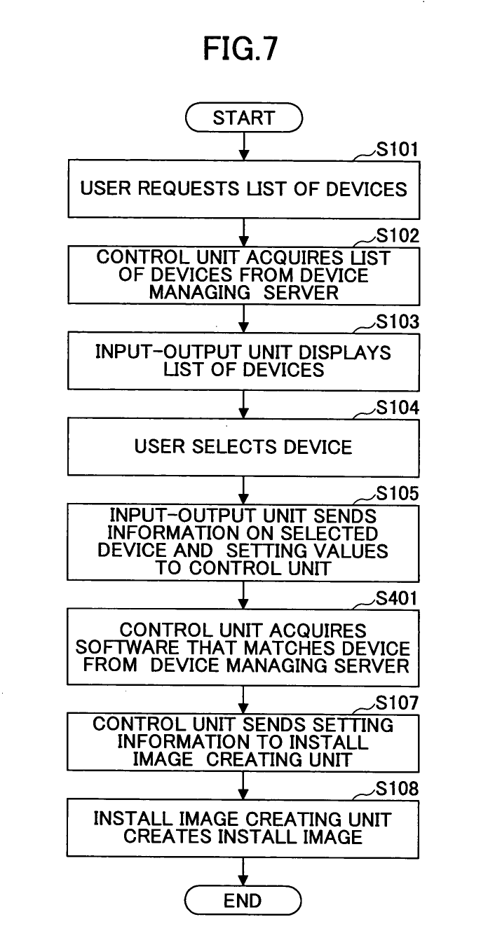

FIG. 7 is a flowchart showing the processing procedure performed by the install image creating device 10 according to the fourth embodiment. The steps common to those shown in FIG. 3 are denoted by common step numbers, and overlapping descriptions are omitted.

In step S401 of the fourth embodiment, the control unit 12 acquires, from the device managing server 20, a software module required for using a selected device.

Subsequent processing procedures are almost the same as those described with FIG. 3, except that the software module acquired from the device managing server 20 is subject to processing.

According to the install image creating system 1 according to the fourth embodiment, the device managing server 20 acquires a software module from the public server 40 in advance. Therefore, when an install image is being created, it is unnecessary to access the public server 40 connected to a wide area network such as the Internet.

In general, the maximum amount of communications traffic between devices connected to different corporate networks is less than that between devices connected within the same corporate network. Thus, it is often difficult to acquire a large-sized software from a network outside the company. This problem can be alleviated with the install image creating system 1 according to the fourth embodiment.

Moreover, it is unnecessary to access the public server 40 several times to acquire the same software module, so that the install image can be efficiently created.

Next, a fifth embodiment is described. The structure of the install image creating system 1 according to the fifth embodiment is the same as that of the first embodiment (FIG. 1). In the fifth embodiment, similarly to the fourth embodiment, the device managing server 20 periodically searches for a software module required for the network device 30 that is being managed. When a software module that is not stored in the device managing server 20, or a newer version than the software module stored in the device managing server 20 is found, the device managing server 20 acquires such a software module in advance.

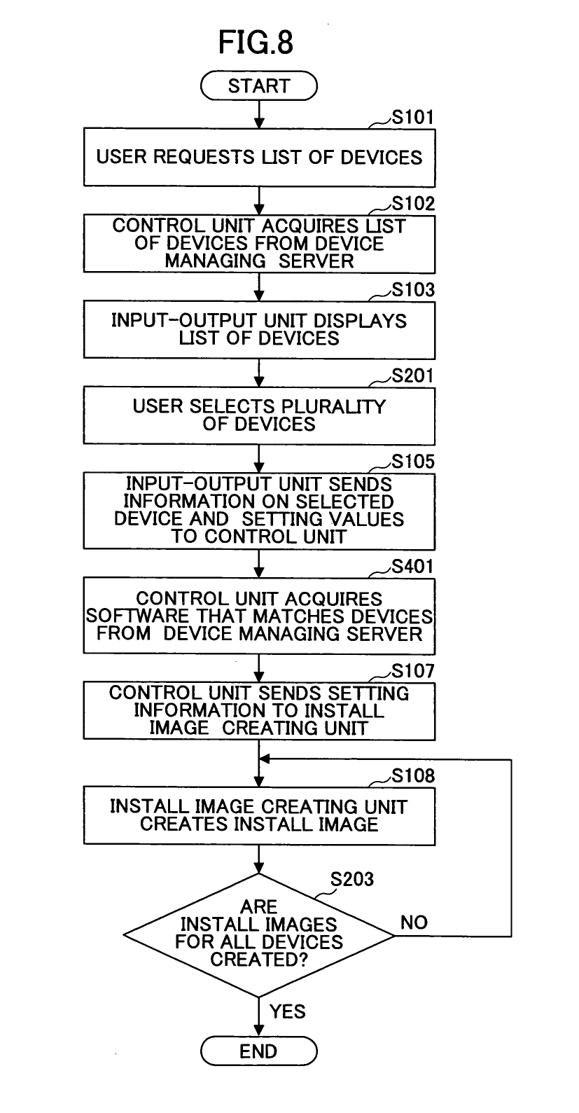

FIG. 8 is a flowchart showing the processing procedure performed by the install image creating device 10 according to the fifth embodiment. The steps common to those shown in FIG. 3 or FIG. 7 are denoted by common step numbers, and overlapping descriptions are omitted.

The relationship between the fifth embodiment and the fourth embodiment is the same as the relationship between the second embodiment and the first embodiment.

In other words, the fifth embodiment is almost the same as the fourth embodiment, except that a plurality of selected devices is subject to processing in the fifth embodiment.

According to the install image creating system 1 of the fifth embodiment, even when install images are created for a plurality of devices, the same effects as the fourth embodiment can be achieved.

Next, a sixth embodiment is described. The structure of the install image creating system 2 according to the sixth embodiment is the same as that of the third embodiment (FIG. 5). In the sixth embodiment, similarly to the fourth and fifth embodiments, the device managing server 20 periodically searches for a software module required for the network device 30 that is being managed. When a software module that is not stored in the device managing server 20, or a newer version than the software module stored in the device managing server 20 is found, the device managing server 20 acquires such a software module in advance.

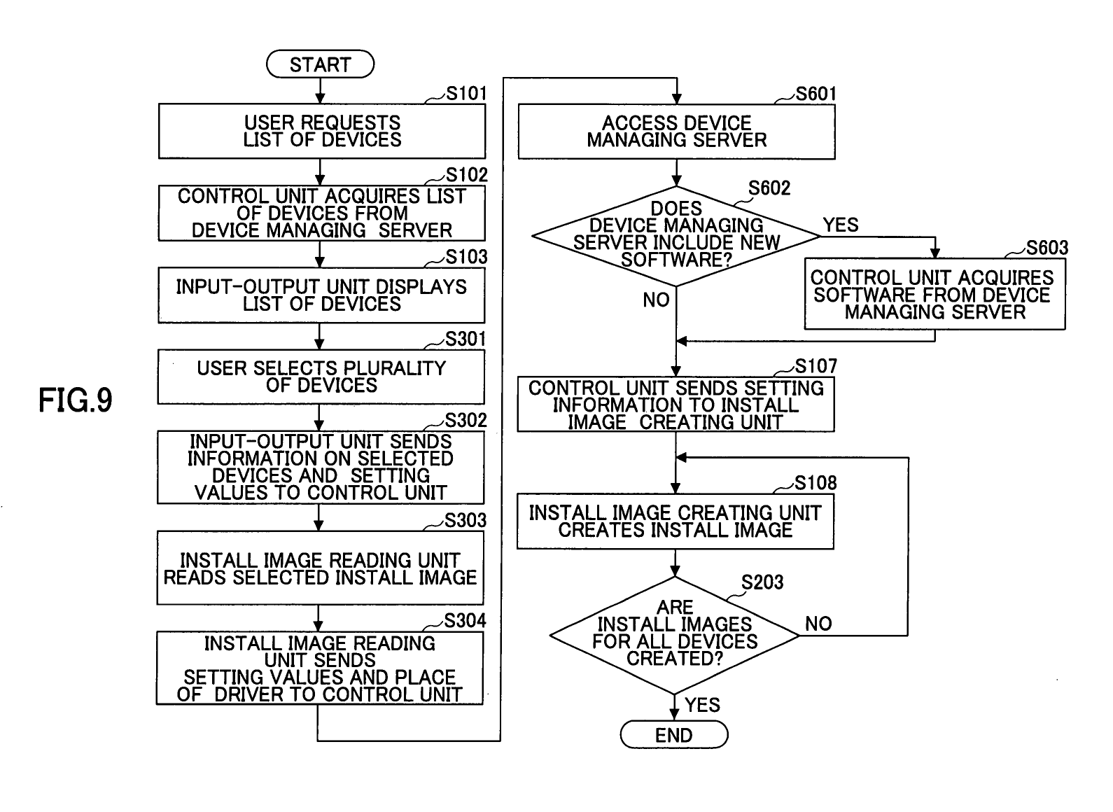

FIG. 9 is a flowchart showing the processing procedure performed by the install image creating device 50 according to the sixth embodiment. The steps common to those shown in FIG. 6 are denoted by common step numbers, and overlapping descriptions are omitted.

The sixth embodiment is different from the third embodiment in that the software module is acquired from the device managing server 20 instead of the public server 40.

In other words, in step S601, the control unit 12 accesses the device managing server 20 based on the information on where the software module is stored, and if a new version of the software module is released (Yes at step S602), the control unit 12 acquires the new version from the device managing server 20 (step S603). Other processing procedures are the same as those of the third embodiment.

The install image creating system 2 according to the sixth embodiment can reduce the amount of network traffic compared to the install image creating system 2 according to the third embodiment, so that install images can be efficiently created.

According to one embodiment of the present invention, it is possible to prevent creating an install image including a wrong software module due to an erroneous input by the user.

Further, according to one embodiment of the present invention, even when install images are created for a plurality of devices, it possible to prevent creating an install image including a wrong software module due to an erroneous input by the user, and enhance efficiency.

Further, according to one embodiment of the present invention, it is possible to create an install image including the latest software module without difficulty and without errors.

Further, according to one embodiment of the present invention, it is possible to reduce the amount of communication traffic, and to efficiently create an install image.

The present invention is not limited to the specifically disclosed embodiment, and variations and modifications may be made without departing from the scope of the present invention.

The present application is based on Japanese Priority Patent Application No. 2005-155234, filed on May 27, 2005, the entire contents of which are hereby incorporated by reference.

What is claimed is:

1. An apparatus for constructing an environment for installing a software for using a device, comprising:
an acquiring unit configured to acquire, through a network, device information on the device;
an obtaining unit configured to obtain the software for using the device based on the device information acquired by the acquiring unit;
a setting unit configured to set a setting value for using the device, and associate the setting value with the software obtained by the obtaining unit; and
a creating unit configured to create an install image with which the software is installed, based on the obtained software and the setting value associated with the software.

2. The apparatus according to claim 1, further comprising:
a selecting unit configured to display a list of the device information acquired by the acquiring unit, so that at least one device is selected from the list, wherein
the setting unit sets a setting value for using the at least one device selected.

3. The apparatus according to claim 2, wherein
when a plurality of devices of the same model are selected,
the obtaining unit obtains a software common to the plurality of devices, and
the creating unit creates install images based on the obtained software common to the plurality of devices, for each of the plurality of devices.

4. The apparatus according to claim 1, further comprising:
a managing unit configured to manage an existing install image created by the creating unit, wherein
the obtaining unit determines whether a software to be obtained according to the acquired device information is newer than a software included in the existing install image managed by the managing unit, and
obtains the software to be obtained according to the device information, when the software to be obtained according to the device information is newer than the software included in the existing install image managed by the managing unit.

5. The apparatus according to claim 4, wherein
when the software to be obtained according to the device information is not newer than the software included in the existing install image managed by the managing unit,
the creating unit creates an install image with the software included in the existing install image managed by the managing unit.

6. A method of constructing an environment for installing a software for using a device, comprising:
acquiring, through a network, device information on the device;
obtaining the software for using the device based on the device information acquired at the acquiring;
setting a setting value for using the device, and associating the setting value with the software obtained at the obtaining; and
creating an install image with which the software is installed, based on the obtained software and the setting value associated with the software.

7. The method according to claim 6, further comprising:
displaying a list of the device information acquired at the acquiring, so that at least one device is selected from the list, wherein
the setting includes setting a setting value for using the at least one device selected.

8. The method according to claim 7, wherein
when a plurality of devices of the same model are selected,
the obtaining includes obtaining a software common to the plurality of devices, and
the creating includes creating install images based on the obtained software common to the plurality of devices, for each of the plurality of devices.

9. The method according to claim 6, further comprising:
managing an existing install image created at the creating, wherein
the obtaining includes determining whether a software to be obtained according to the acquired device information is newer than a software included in the existing install image managed at the managing, and
obtaining the software to be obtained according to the device information, when the software to be obtained according to the device information is newer than the software included in the existing install image managed at the managing.

10. The method according to claim 9, wherein
when the software to be obtained according to the device information is not newer than the software included in the existing install image managed at the managing,
the creating includes creating an install image with the software included in the existing install image managed at the managing.

11. A program product that causes a computer to execute a procedure for constructing an environment for installing a software for using a device, the procedure comprising steps of:
acquiring, through a network, device information on the device;
obtaining the software for using the device based on the device information acquired at the acquiring;
setting a setting value for using the device, and associating the setting value with the software obtained at the obtaining; and
creating an install image with which the software is installed, based on the obtained software and the setting value associated with the software.

12. The program product according to claim 11, further comprising a step of:
displaying a list of the device information acquired at the acquiring, so that at least one device is selected from the list, wherein
the setting includes setting a setting value for using the at least one device selected.

13. The program product according to claim 12, wherein
when a plurality of devices of the same model are selected,
the obtaining includes obtaining a software common to the plurality of devices, and
the creating includes creating install images based on the obtained software common to the plurality of devices, for each of the plurality of devices.

14. The program product according to claim 11, further comprising a step of:
managing an existing install image created at the creating, wherein
the obtaining includes determining whether a software to be obtained according to the acquired device information is newer than a software included in the existing install image managed at the managing, and
obtaining the software to be obtained according to the device information, when the software to be obtained according to the device information is newer than the software included in the existing install image managed at the managing.

15. The program product according to claim 14, wherein
when the software to be obtained according to the device information is not newer than the software included in the existing install image managed at the managing,
the creating includes creating an install image with the software included in the existing install image managed at the managing.

16. A computer-readable recording medium storing therein the program product according to claim 11.
